(19) United States
(12) Patent Application Publication
(10) Pub. No.: US 2020/0061579 A1
(43) Pub. Date: Feb. 27, 2020

(54) Molecular Imprinted Polymers for Chemosensing

(71) Applicant: National University of Singapore, Singapore (SG)

(72) Inventors: Christina Li Lin CHAI, Singapore (SG); Yen Wah TONG, Singapore (SG); Chee Yew LEONG, Singapore (SG); Cheng LI, Singapore (SG); Mun Hong NGAI, Singapore (SG)

(21) Appl. No.: 16/606,177

(22) PCT Filed: May 16, 2018
(86) PCT No.: PCT/SG2018/050239

§ 371 Date: Oct. 17, 2019

Related U.S. Application Data
(60) Provisional application No. 62/506,714, filed on May 16, 2017.

(51) Int. Cl. B01J 20/26; C08F 220/06; C08F 220/56; C08F 220/14; G01N 21/64

(52) U.S. Cl. CPC B01J 20/268; C08F 220/06; C08F 220/56; G01N 2021/6439; G01N 21/6428; C08F 2810/20; C08F 220/14

(57) ABSTRACT

Disclosed herein is a method of manufacturing molecularly imprinted polymers for scarce target molecules that are made using surrogate molecules. Also disclosed herein are the molecularly imprinted polymers and their use in detecting the selected target molecules, particularly through the binding of a fluorescent surrogate molecule to the molecularly imprinted polymers that is then displaced from the molecularly imprinted polymer upon contact with the target molecule.

### CROSS-REFERENCE TO RELATED APPLICATIONS

This application is a US 371 Application from PCT/SG2018/050239 filed May 16, 2018, which claims priority to U.S. Provisional Application No. 62/506,714 filed May 16, 2017, the technical disclosures of which are hereby incorporated herein by reference.

### FIELD OF INVENTION

This invention relates to molecular imprinted polymers bound with complementary fluorescent tags, and the use of said materials for detecting analytes in water.

### BACKGROUND

The listing or discussion of a prior-published document his specification should not necessarily be taken as an acknowledgement that the document is part of the state of the art or is common general knowledge.

In recent years, the global incidence of algal blooms from toxic phytoplankton species has increased both in frequency and distribution. Phycotoxins produced by harmful algal blooms (HABs), dinoflagellates in particular, can poison marine organisms and humans when they exceed certain thresholds. There are also concerns that drinking water may also be contaminated by these metabolites (D. Caron, et al., Water Research, 2010, 44, 385-416).

In developed countries, consumers' assessment of the quality of drinking water goes beyond the regulatory requirements for chemical and biological contaminants that are detrimental to health. Quality is perceived to be intricately linked to the taste and odour of drinking water, which has become one of the rising concerns of water suppliers. Two compounds, geosmin (GSM) and 2-methylisoborneol (2-MIB), have been identified as being responsible for the earthy and musty taste and odour of water (J. Mallevialle, I. H. Suffet, Identification and Treatment of Tastes and Odors in Drinking Water, American Water Works Association, Denver, 1987). These compounds are non-toxic natural contaminants that arise from various algae and bacteria in water supply sources. The problem is especially severe when there are incidences of algal blooms in water catchment areas.

Although there are existing methods for the detection of algal metabolites, they are neither practical nor efficient. Typically, a large number of water samples are collected at various locations and each sample is pre-treated to isolate and concentrate the substances prior to gas chromatography-mass spectrometry (GC-MS) analysis. Examples of pre-treatment methods coupled to GC-MS include:
closed-loop stripping analysis (D. Mitjans, et al., Water Sci. Technol., 2005, 52, 145-150; M. J. McGuire, et al., J-Am. Water Works Assoc., 1981, 73, 530-537; S. W. Krasner, et al., Abstr. Pap. Am. Chem. Soc., 1980, 180, 5-ENVR);
liquid-liquid microextraction (C. Cortada, et al., J. Chromatogr. A, 2011, 1218, 17-22; H. S. Shin, et al., Chromatographia, 2004, 59, 107-113);
stir bar sorptive extraction (R. R. Madrera, et al., J. Food Sci., 2011, 76, C1326-C1334; A. M. C. Ferreira, Anal. Bioanal. Chem., 2011, 399, 945-953; P. Grossi, et al., J. Sep. Sci., 2008, 31, 3630-3637);
purge and trap (A. Salemi, et al., J. Chromatogr. A, 2006, 1136, 170-175; X. W. Deng, et al., J. Chromatogr. A, 2011, 1218, 3791-3798);
solid phase microextraction (S. Suurnakki, et al., Water Res., 2015, 68, 56-66; R. McCallum, et al., Analyst, 1998, 123, 2155-2160; Y. H. Sung, et al., Talanta, 2005, 65, 518-524; K. Salto, et al., J. Chromatogr. A, 2008, 1186, 434-437; J. Parinet, et al., Int. J. Environ. Anal. Chem., 2011, 91, 505-515); and
membrane extraction (M. J. Yang, et al., Anal. Chem., 1994, 66, 1339-1346; A. K. Zander, et al., Water Res., 1997, 31, 301-309).

The whole detection process is laborious and therefore there remains a need for a more efficient system.

In addition, there are inherent limitations on what an ideal water monitoring protocol needs to demonstrate. In the first instance, the amount of time and effort needed to prepare a sample for analysis and the subsequent analysis of each sample have to be low to enable a quick response time to any potential bloom of algae. In addition, the costs associated with the instruments used and/or the use of complex instrument time has to be kept low to ensure cost-effectiveness. Most importantly, the method of detection has to be sensitive and selective so that it can be used for accurate detection of target analytes in water samples.

Given the above, there remains a need for new materials and/or devices for efficient on-site detection of algal metabolites in water. It is envisaged that the materials can be used in preliminary screening of water samples in the field to identify the affected samples before sending them to laboratories for further quantification.

A class of material that can be used for chemosensing are molecular imprinted polymers (MIPs), which are synthetic polymers designed to act as artificial receptors. The recognition sites on the polymers are synthesised through an imprinting process, whereby polymerisation is effected around a template molecule to form a mould-like shell (L. Chen, et al., Chem. Soc. Rev., 2011, 40, 2922-2942). Removal of the template results in an imprinted memory of its shape onto the polymer. This imprint is complementary to the target molecule in size, shape, and physicochemical properties and is capable of repeating the binding of the template (K. Haupt, et al., Top. Curr. Chem., 2012, 325, 1-28).

### SUMMARY OF INVENTION

The following numbered clauses detail aspects and embodiments of the current invention.

1. A method for providing a molecularly imprinted polymer using a surrogate molecule in place of a target molecule, the process comprising the steps of:
(i) selecting a target molecule and then selecting a surrogate molecule having a shape similarity score of at least 0.80; and
(ii) using the surrogate molecule to form a library molecularly imprinted polymers by reaction of a functional monomer and a crosslinking agent in the presence of the surrogate molecule, where the ratio of surrogate molecule to functional monomer is from 1:2 to 1:6 and the ratio of functional monomer to crosslinking agent in each library member is from 1:1 to 1:2.5 and establishing the binding capacity (Q_{MIP}) for each library member to the target molecule and/or the surrogate molecule;
(iii) forming a corresponding library of non-molecularly imprinted polymers by reaction of a functional monomer and a crosslinking agent in the absence of the surrogate molecule, where the ratio of functional monomer:crosslinking agent in each library member is from 1:1 to 1:2.5 and establishing the binding capacity (Q_{NIP}) for each library member to the target molecule and/or the surrogate molecule;
(iv) selecting a molecularly imprinted polymer for use in detection of the target molecule where the binding efficiency of the molecularly imprinted polymer (Q_{MIP} divided by the corresponding Q_{NIP}) is greater than or equal to 2 for the target molecule and/or or greater than or equal to 2.5 for the surrogate molecule.
2. The method according to Clause 1, wherein the shape similarity score is obtained using a computational shape-based screening algorithm, optionally wherein the surrogate molecule has a shape similarity score of at least 0.85.
3. The method according to Clause 1 or Clause 2, wherein the functional monomer is selected from one or more of the group consisting methacrylic acid, methyacrylamide, and methyl methacrylate.
4. The method according to any one of the preceding clauses, wherein the crosslinking agent is selected from one or more of the group consisting of ethylene glycol dimethacrylate and trimethylolpropane trimethacrylate.
5. The method according to any one of the preceding clauses, wherein the target molecule is a metabolite of a microorganism.
6. The method according to Clause 5, wherein the microorganism is an algae.
7. The method according to Clause 5 or Clause 6, wherein the metabolite is geosmin or 2-methylisoborneol, optionally wherein the polymer selected to detect geosmin has a limit of detection of from 60 to 80 ppb without a preconcentration step being conducted on an analyte containing geosmin, and the polymer selected to detect 2-methylisoborneol has a limit of detection of from 40 to 60 ppb without a preconcentration step being conducted on an analyte containing 2-methylisoborneol.
8. The method according to any one of the preceding clauses, wherein the ratio where the ratio of surrogate molecule to functional monomer is from 1:2 to 1:4 and the ratio of functional monomer to crosslinking agent is from 1:1 to 1:2.5.
9. The method according to any one of the preceding clauses, wherein the reaction of a functional monomer and a crosslinking agent in the presence of the surrogate molecule is a self-assembly reaction.
10. The method according to any one of the preceding clauses, wherein the molecularly imprinted polymer selected in step (iv) of Clause 1 is the polymer with the greatest binding efficiency.
11. The method according to any one of the preceding clauses, wherein the method further comprises a step of forming a detection device comprising the selected molecularly imprinted polymer.
12. A molecularly imprinted polymer suitable for the detection of a target molecule, the polymer formed from:
13. a functional monomer selected from one or more of the group consisting of methacrylic acid, methyacrylamide, and methyl methacrylate;
14. a crosslinking agent selected ethylene glycol dimethacrylate and/or trimethylolpropane trimethacrylate; and
15. a surrogate molecule used to form cavities in the polymer that have an affinity for the target molecule, wherein the molecularly imprinted polymer has:
16. a binding capacity for the target molecule that is at least 60% of the binding capacity obtained from a molecularly imprinted polymer produced using the target molecule itself; and
17. a binding capacity for the target molecule that is from 10 to 30 μmol/g; and/or

the polymer comprises a crosslinked polymer with a plurality of cavities, where:

1. the polymer is formed from a functional monomer selected from one or more of the group consisting of methacrylic acid, methyacrylamide, and methyl methacrylate and a crosslinking agent selected ethylene glycol dimethacrylate and/or trimethylolpropane trimethacrylate;
2. the cavities have a first affinity for a surrogate molecule and a second affinity for the target molecule, where the first affinity is greater than or equal to the second affinity, wherein the molecularly imprinted polymer has:
3. a binding capacity for the target molecule that is at least 60% of the binding capacity obtained from a molecularly imprinted polymer produced using the target molecule itself; and
4. a binding capacity for the target molecule that is from 10 to 30 μmol/g.

13. The polymer according to Clause 12, wherein:

(a) the ratio of functional monomer to crosslinking agent is from 1:1 to 1:2.5; and/or
(b) the polymer has a binding efficiency for the target molecule that is greater than or equal to 2.

14. The polymer according to Clause 12 or Clause 13, wherein the polymer further comprises a fluorescently-labelled surrogate of the target molecule where the surrogate is a weaker binder than the target molecule, such that it is displaced from the polymer upon exposure of the polymer to the target molecule.

15. The polymer according to any one of Clauses 12 to 14, wherein the target molecule is geosmin, optionally wherein the polymer has a binding capacity of from 10 to 15 μmol/g, such as 11.6 μmol/g for geosmin.

16. The polymer according to Clause 15, wherein the functional monomer is methacrylic acid, the crosslinking agent is trimethylolpropane trimethacrylate and the ratio of functional monomer:crosslinking agent is 1:1.

17. The polymer according to Clause 15 or Clause 16, wherein the polymer further comprises a fluorescently-labelled surrogate of geosmin where the surrogate is a weaker binder than geosmin, such that it is displaced from the polymer upon exposure of the polymer to geosmin.

18. The polymer according to Clause 17, wherein the fluorescently-labelled surrogate of geosmin is [(4aS,8aS)-decalin-1-yl]-2-(7-amino-4-methyl-2-oxo-chromen-3-yl)acetate.

19. The polymer according any one of Clauses 12 to 14, wherein the target molecule is 2-methylisoborneol, optionally wherein the polymer has a binding capacity of from 15 to 20 μmol/g, such as 18.9 μmol/g for 2-methylisoborneol.

20. The polymer according to Clause 19, wherein the functional monomer is methacrylic acid, the crosslinking agent is ethylene glycol dimethacrylate and the ratio of functional monomer:crosslinking agent is 1:2.5.

21. The polymer according to Clause 19 or Clause 20, wherein the polymer further comprises a fluorescently-labelled surrogate of 2-methylisoborneol where the surrogate is a weaker binder than 2-methylisoborneol, such that it is displaced from the polymer upon exposure of the polymer to 2-methylisoborneol.

22. The polymer according to Clause 21, wherein the fluorescently-labelled surrogate of 2-methylisoborneol is cyclohexyl-2-(7-amino-4-methyl-2-oxo-chromen-3-yl)acetate.

23. A method of detecting the concentration of a target molecule in a sample with a molecularly imprinted polymer, wherein the method comprises the steps of:

(a) providing a molecularly imprinted polymer as described in any one of Clauses 14, 17, 18, 21 and 22 and a sample for analysis;
(b) contacting the molecularly imprinted polymer with the sample for a period of time to form a sample-polymer mixture;
(c) separating the sample-polymer mixture to provide a contacted sample; and
(d) qualitatively detecting the presence of the target molecule in the contacted sample by observing the presence of fluorescence in the contacted sample or quantitatively determining the concentration of the target molecule in the contacted sample by measuring the fluorescence in the contacted sample using a fluorescence spectrometer.

24. The method according to Clause 23, wherein the target molecule is geosmin or 2-methylisoborneol, optionally wherein the polymer used to detect geosmin has a limit of detection of from 60 to 80 ppb, and the polymer used to detect 2-methylisoborneol has a limit of detection of from 40 to 60 ppb.

25. The method according to Clause 23 or Clause 24, wherein before step (b), the sample is subjected to a preconcentration process that comprises the steps of:

(i) contacting the sample with a preconcentration material to capture at least the target molecule;
(ii) subsequently releasing the target molecule from the preconcentration material to provide a preconcentrated sample that is then used in steps (b) to (d) of Clause 23.

26. The method according to Clause 25, wherein the preconcentration material is a reverse phase material.

27. The method according to Clause 26, wherein the reverse phase material is a C₁₆-C₁₈ reverse phase material.

28. The method according to Clause 25, wherein the preconcentration material is a molecularly imprinted polymer suitable for the capture and release of a target molecule, the polymer formed from:

1. a functional monomer selected from one or more of the group consisting of methacrylic acid, methyacrylamide, and methyl methacrylate;
2. a crosslinking agent selected ethylene glycol dimethacrylate and/or trimethylolpropane trimethacrylate; and
3. a surrogate molecule used to form cavities in the polymer that have an affinity for the target molecule, wherein the molecularly imprinted polymer has:
4. a binding capacity for the target molecule that is at least 60% of the binding capacity obtained from a molecularly imprinted polymer produced using the target molecule itself;
5. a binding capacity for the target molecule that is from 10 to 30 μmol/g; and
6. a binding efficiency for the target molecule that is greater than or equal to 2.

29. The method according to Clause 28, wherein the ratio of functional monomer to crosslinking agent in the molecularly imprinted polymer is from 1:1 to 1:2.5.

30. The method according Clause 28 or Clause 29, wherein the target molecule for is geosmin, optionally wherein the polymer has a binding capacity of from 10 to 15 μmol/g, such as 11.6 μmol/g for geosmin.

31. The method according to Clause 30, wherein the functional monomer is methacrylic acid, the crosslinking agent is trimethylolpropane trimethacrylate and the ratio of functional monomer:crosslinking agent is 1:1.

32. The method according to Clause 30 or Clause 31, wherein the preconcentration step lowers the limit of detection to 20 ppt of geosmin in a sample.

33. The method according to 28 or Clause 29, wherein the target molecule is 2-methylisoborneol, optionally wherein the polymer has a binding capacity of from 15 to 20 μmol/g, such as 18.9 μmol/g for 2-methylisoborneol.

34. The polymer according to Clause 33, wherein the functional monomer is methacrylic acid, the crosslinking agent is ethylene glycol dimethacrylate and the ratio of functional monomer:crosslinking agent is 1:2.5.

35. The method according to Clause 33 or Clause 34, wherein the preconcentration step lowers the limit of detection to 14 ppt of 2-methylisoborneol in a sample.

36. A device to detect a target molecule qualitatively and/or quantitatively in a sample for analysis, where the device comprises:

1. a preconcentration section to receive a sample and capture at least the target molecule on a preconcentration material;
2. a preconcentration sample section to receive a preconcentrated sample from the preconcentration section; and
3. a detection section that receives the preconcentrated sample and qualtatively and/or quantitatively detects the target molecule, wherein:
4. the detection section comprises a molecularly imprinted polymer as described in any one of Clauses 14, 17, 18, 21 and 22.

37. The device according to Clause 36, wherein the preconcentration material is a reverse phase material as described in Clauses 26 and 27 or a molecularly imprinted polymer as described in Clauses 12, 13, 15, 16, 19 and 20.

### DRAWINGS

FIG. 1 Depicts the concept of synthesising the MIPs using surrogate template, and using the MIP bound with a tagged molecule for detecting the target analyte via the displacement of the tagged molecule by the analyte.

FIG. 2 Depicts the chemical structures of GSM (1) with cis-decahydro-1-naphthol (3) as its surrogate template, and 2-MIB (2) with 1-bromoadamantane (4) as its surrogate template.

FIG. 3 Depicts the adsorption kinetic curve of (a) GSM with MIP-GSMS/MAA/TRIM2, with the concentration of GSM solution at 1.37 mmol L⁻¹; and (b) 2-MIB with MIP-MIBS/MAA/EDGMA2, with the concentration of 2-MIB solution at 1.37 mmol L⁻¹.

FIG. 4 Depicts (a-c) a comparison of the binding efficiencies of combinatorially prepared MIP-GSMS towards GSM surrogate (cis-decahydro-1-naphthol). Abbreviations of the sample labels are as follows: Molecular Imprinted Polymer-GSM Surrogate/Functional Monomer/Crosslinker (conditions number), for example, MIP-GSMS/MAA/TRIM1.

FIG. 5 Depicts (a-c) a comparison of the binding efficiencies of combinatorially prepared MIP-GSMS towards GSM. The mole ratio of template to the functional monomer was 1:2, 1:4 and 1:6. The mole ratio of functional monomer to EGDMA was set to 1:2.5, and the mole ratio of functional monomer to TRIM was set to 1:1. Abbreviations of the sample labels follow that of FIG. 4.

FIG. 6 Depicts (a) the binding efficiencies of various MIP-MIBS synthesised using MAA as the functional monomer, EGDMA or TRIM as the cross-linker, with 2-MIB; and (b) the binding capacities of these MIP-MIBS with 2-MIB, with the concentration of 2-MIB solution at 1.37 mmol L⁻¹.

FIG. 7 Depicts the representative FESEM images of (a-c) MIP-GSMS/MAA/TRIM2 at ×5,000, ×2,500 and ×45,000 magnifications respectively; and (d) NIP-MAA/TRIM2 at ×2,000 magnification. The sizes of the polymeric nanoparticles were measured directly from the FESEM images, with at least 50 particles from different sample areas measured.

FIG. 8 Depicts the FT-IR spectra of (a) MIP-GSMS/MAA/TRIM2 before the removal of template; (b) MIP-GSMS/MAA/TRIM2 after the removal of template; and (c) NIP-MAA/TRIM2.

FIG. 9 Depicts the binding capacities of (a) MIP-GSMS/MAA/TRIM2, and (b) MIP-MIBS/MAA/EGDMA2 for GSM and 2-MIB respectively, at a concentration of 1.37 mmol L⁻¹ for both the GSM and 2-MIB solutions.

FIG. 10 Depicts (a) the synthesis of a fluorescent tag 6 by conjugating 7-amino-4-methyl-3-coumaric acid (5) with cis-decahydro-1-naphthol (3); (b) comparison of the binding capacities of MIP-GSMS/MAA/TRIM2 and NIP-MAA/TRIM2 with the fluorescent tag 6 and with GSM respectively; (c) the amount of fluorescent tag 6 displaced in relation to the concentration of GSM solutions from 0.08 to 20 mg L⁻¹; and (d-e) visual comparison of the fluorescence intensities of the solution after incubating the MIP-GSMS with bound fluorescent-tagged substrate in the presence of GSM at 80 ppb and 160 ppb respectively. The control sample contained the same amount of materials and solvent, but without GSM.

FIG. 11 Depicts (a) the synthesis of a fluorescent tag 8 by conjugating 7-amino-4-methyl-3-coumaric acid (5) with cyclohexanol (7); (b) the amount of fluorescent tag 6 displaced in relation to the concentration of 2-MIB solutions from 0.06 to 1.25 mg L⁻¹; and (c) the visual comparison of the fluorescence intensities of the solutions after incubating 15 mg of MIP-MIBS with bound fluorescent-tagged substrate in the presence of 2-MIB at various concentrations (60 to 320 ppb) in 1 mL of acetonitrile. The control sample contained the same amount of materials and solvent, but without 2-MIB.

FIG. 12 Depicts a comparison of the binding capacities of MIP-GSMS/MAA/TRIM2 for GSM and 1-naphthylamine respectively, with both solutions at a concentration of 1.37 mmol L⁻¹.

FIG. 13 Depicts (a) the pre-concentration process to obtain a concentrated sample of GSM for detection using MIP-GSMS with bound fluorescent-tagged substrate; (b) GC-MS chromatogram of the impurities of the pre-concentrated reservoir water after pre-concentration by SPE. Compound A was identified as 2-(2-butoxyethoxy)ethan-1-ol, while compound E was identified as 2,4,7,9-tetramethyldec-5-yne-4,7-diol. Compounds B, C, and D were unknown.

FIG. 14 Depicts (a) the visual comparison of the fluorescence intensities of the solutions after incubating 15 mg of MIP-GSMS with bound fluorescent-tagged substrate 6 in various samples:Control 1 contained 1 mL MeOH/H₂O (v/v 50:50); sample “1 mL field water” contained 10 ng L⁻¹ geosmin in MeOH/H₂O (v/v 50:50); control 2 contained 1 mL of MeOH; and sample “1 mL concentrated field water” contained 1 mL of concentrated field sample in MeOH; and (b) the amount of fluorescent-tagged substrate 6 displaced from the respective samples.

### DESCRIPTION

It has been surprisingly found that selected surrogate molecules can be used to manufacture molecularly imprinted polymers (MIPs) on large scale that are useful in the detection of target compounds that cannot be provided in sufficient quantities to generate a MIP on a commercial scale.

Thus, in a first aspect of the invention, there is provided a method for providing a molecularly imprinted polymer using a surrogate molecule in place of a target molecule, the process comprising the steps of:

(i) selecting a target molecule and then selecting a surrogate molecule having a shape similarity score of at least 0.80; and
(ii) using the surrogate molecule to form a library molecularly imprinted polymers by reaction of a functional monomer and a crosslinking agent in the presence of the surrogate molecule, where the ratio of surrogate molecule to functional monomer is from 1:2 to 1:6 and the ratio of functional monomer to crosslinking agent in each library member is from 1:1 to 1:2.5 and establishing the binding capacity (Q_{MIP}) for each library member to the target molecule and/or the surrogate molecule;
(iii) forming a corresponding library of non-molecularly imprinted polymers by reaction of a functional monomer and a crosslinking agent in the absence of the surrogate molecule, where the ratio of functional monomer:crosslinking agent in each library member is from 1:1 to 1:2.5 and establishing the binding capacity (Q_{NIP}) for each library member to the target molecule and/or the surrogate molecule;
(iv) selecting a molecularly imprinted polymer for use in detection of the target molecule where the binding efficiency of the molecularly imprinted polymer (Q_{MIP} divided by the corresponding Q_{NIP}) is greater than or equal to 2 for the target molecule and/or greater than or equal to 2.5 for the surrogate molecule.

The above aspect may be generally applied, but has been demonstrated herein with respect to geosmin (GSM) and 2-methylisoborneol (2-MIB). As noted above, the design of the detection system for GSM and MIB is based on molecular imprinted polymers (MIPs) for the recognition of GSM and 2-MIB. Clearly, the choice of template determines the effectiveness of the imprinting methods for molecular recognition. In an ideal situation, the template would be the target molecule itself. This, however, is not plausible due to their scarcity and when the metabolites are toxic, there is also an issue of safety in handling the toxins. To address this issue, a computational selection approach was used in the selection of an appropriate template (surrogate) for polymer synthesis. Thus, a range of MIPs were synthesised using a template (or surrogate) that best mimics either GSM or 2-MIB according to the selection criteria.

Identifying the best polymer precursors is no easy task due to the large library of functional monomers and cross-linking. To overcome this issue, a combinatorial recipe was selected and used in preparing MIPs. This method involved manufacturing MIPs using the selected surrogate a polymer and a crosslinking agent in various ratios to generate a library of MIPs that were then analysed. In addition, the polymer and crosslinking agent were also varied. The “best” MIP-GSM and MIP-MIB templates were then chosen due to their comparatively higher specific selectivity (i.e. binding efficiency) for the desired analyte.

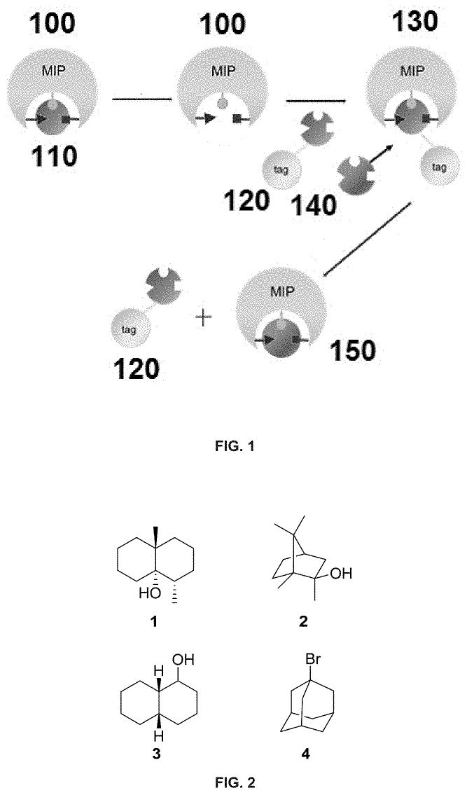

In order to more easily determine the presence of the target analyte, a simple qualitative and quantitative fluorescence test using the selected MIPs was also developed. A cartoon depiction of the detection concept is shown in FIG. 1. As discussed below in more detail, a fluorescent tagged substrate that is able to bind well to the MIP was also designed and synthesised. The selection of this substrate is important as this substrate needs to have a good binding ability to the MIP (to minimise leaching) but the binding efficiency must be lower than that of the actual analyte to be tested. This is so that in the presence of the analyte, the tagged substrate disposed in the cavities of the MIP is displaced and the fluorescence can be observed and measured. The initial finding suggested that the use of a MIP pre-loaded with the fluorescent tagged substrate enabled a minimum detection threshold for geosmin and 2-MIB of 80 ppb and 60 ppb, respectively, to be established.

In FIG. 1, a MIP 100 is made using a surrogate template 110, which is then removed using conventional methods to do so. The resulting MIP 100 may then be incubated with a fluorescently-tagged surrogate compound 120, which binds in the cavities of the MIP to form a complex 130. When the target compound 140 is introduced to the MIP-complex 130, the fluorescently-tagged surrogate compound 120 is displaced from the cavity in the MIP and a MIP-target complex 150 is formed. The fluorescently-tagged surrogate compound 120 may then be detected, preferably following separation of the MIP from the sample solution.

In embodiments herein, the word “comprising” may be interpreted as requiring the features mentioned, but not limiting the presence of other features. Alternatively, the word “comprising” may also relate to the situation where only the components/features listed are intended to be present (e.g. the word “comprising” may be replaced by the phrases “consists of” or “consists essentially of”). It is explicitly contemplated that both the broader and narrower interpretations can be applied to all aspects and embodiments of the present invention. In other words, the word “comprising” and synonyms thereof may be replaced by the phrase “consisting of” or the phrase “consists essentially of” or synonyms thereof and vice versa.

When used herein, the term “target molecule” relates to any material that may be usefully detected using a MIP. More particularly, the term “target molecule” herein relates to a molecule that is not available in sufficient quantities to be used to generate a MIP directly on a commercial scale. Examples of such target molecules may be metabolic products of a microorganism that is known to be problematic (e.g. its presence causing environmental/quality issues, such as affecting the smell of a body of water, the smell of water intended for human consumption, or toxicity issues due to metabolites of the microorganism). Examples of such problematic microorganisms include algae, which in certain circumstances are known to increase their population exponentially in an algal bloom. Particular examples of target molecules that may be mentioned herein include geosmin and 2-methylisoborneol, which are produced in minute quantities by certain microorganisms, such as algae.

It is important to note that in cases where there is a plentiful and cheap supply of a target molecule, it would be preferred to make use of said molecule in preference to the use of a surrogate. As such, the methods described herein may be particularly useful where the target molecule is either not available commercially at all, is hard to make or would be prohibitively expensive (either to make or buy) on a scale suitable for the commercial development of MIPs based thereon.

When used herein “surrogate molecule” refers to a molecule that is used in place of the target molecule to produce a MIP that with a useful selectivity for the target molecule in question. The surrogate molecule may be selected based on a shape similarity score of at least 0.80 (e.g. 0.85 etc) using any suitable shape similarity model. In general, the surrogate molecule that is selected will have the highest available shape similarity score compared to all other molecules that were considered. A suitable shape similarity model to provide the shape similarity score used to select the surrogate molecule may be a computational shape-based screening algorithm. An example of such an algorithm may be the Schrödinger Release 2015-1 Maestro, version 10.1 from Schrödinger LLC, New York, N.Y. (older or newer variants of the same software may also be used, for example Schrödinger Release 2018-1 Phase).

Molecularly imprinted polymers described herein may be made by self-assembly, which involves the formation of polymer by combining all elements of the MIP and allowing the molecular interactions to form a cross-linked polymer with the template molecule (in this case surrogate molecule) bound within the polymer matrix. The surrogate molecule is then removed by simple extraction techniques. A second method of forming a MIP involves covalently linking the imprint molecule (i.e. surrogate molecule) to the monomer(s) or crosslinking agent(s) used. After polymerization, the surrogate molecule can be chemically cleaved from the polymer (e.g. see Tse Sum Bui, Bernadette, Anal Bioanal Chem. 2010, vol. 398, pp 2481-2492).

When used herein “library molecularly imprinted polymers” refers to the generation of a number of different MIPs through use of combinatorial techniques to generate a number of unique MIPs. The number of MIPs made in the library is not particularly limited (e.g. from 10 to 10,000), but there may be practical constrains on how many combinations can then be tested in the subsequent steps to determine binding efficiency. Any suitable combinatorial methods of forming a number of unique MIPs may be used, but may typically relate to the variation of the functional monomer(s) and crosslinking agent(s) used in combination with the surrogate molecule, as well as varying the proportions of these components. It will be appreciated that the corresponding non-molecularly imprinted polymers are formed using the same techniques—the only difference being that the surrogate molecule is not provided as part of the reaction mixture.

The libraries of molecularly imprinted polymers and non-molecularly imprinted polymers may be formed using any suitable functional monomer(s) and crosslinking agent(s) in any suitable ratio to generate a number of MIPs for testing. Functional monomers when used herein refer to monomeric materials that may be used to form a polymer—whether alone or in combination with other monomeric materials to make a copolymer. It will be appreciated that copolymers require the use of at least two monomeric materials. Functional monomers that may be suitable for use in the combinatorial library of MIPs include, but are not limited to methacrylic acid, methyacrylamide, methyl methacrylate and combinations thereof. Crosslinking agents that may be suitable for use in the combinatorial library of MIPs include, but are not limited to ethylene glycol dimethacrylate, trimethylolpropane trimethacrylate and combinations thereof.

As noted above, the combinatorial libraries (and hence the resulting MIPs) may contain differing ratios of the functional monomer(s):crosslinking agent(s), surrogate molecule:functional monomer(s) and, potentially surrogate molecule:crosslinking agent(s). A suitable ratio of surrogate molecule to functional monomer(s) that may be mentioned herein would be from 1:1 to 1:6 or, more particularly, from 1:2 to 1:4. A suitable ratio of functional monomer(s) to crosslinking agent(s) that may be mentioned herein would be from 0.5:1 to 1:5 or, more particularly, from 1:1 to 1:2.5. A suitable ratio of surrogate molecule to crosslinking agent(s) that may be mentioned herein would be from 1:1 to 1:15 or, more particularly, from 1:2 to 1:10, such as from 1:2 to 1:4.

As noted above, the MIPs and non-molecularly imprinted polymers produced in the libraries of steps (ii) and (iii) above are then tested to obtain the binding capacity (Q) of each library member, which is then used in step (iv) to determine the binding efficiency of each MIP (Q_{MIP}/Q_{NIP}). The binding capacities may be established using the surrogate molecule or, more preferably, the target molecule using any suitable method, such as the method described below in the examples section. It will be appreciated that the binding capacity (and hence efficiency) of the MIPs will differ depending on whether the surrogate molecule or target molecule is used. It would be expected that the binding efficiency will be higher for the surrogate molecule than for the target molecule (as the surrogate molecule was used as the template to produce the MIP). Given this, when the surrogate molecule is used to select the MIP for use in detecting the target molecule, the binding efficiency may be at least 2.5. In contrast, when the target molecule is used to select the MIP for use in detecting the target molecule, the binding efficiency may instead be at least 2.0. In both cases, it will be appreciated that the MIP selected will generally be the MIP with the highest/greatest binding efficiency from the library in question.

The selected MIPs may have a limit of detection measured in parts per billion (ppb). For example, when the metabolite is geosmin, the polymer selected to detect geosmin may have a limit of detection of from 60 to 80 ppb without a preconcentration step being conducted on an analyte containing geosmin. When the metabolite is 2-methylisoborneol, the polymer selected to detect 2-methylisoborneol may have a limit of detection of from 40 to 60 ppb without a preconcentration step being conducted on an analyte containing 2-methylisoborneol. As noted above, the limit of detection may refer to the use of a MIP that has been loaded with a fluorescent substrate that has a binding efficiency less than that of the target molecule, making it easily displaced by said target molecule. This will be discussed in more detail below.

As will be appreciated, the selected MIPs may be used as part of a detection device. Such devices will be discussed in greater detail hereinbelow.

In a second aspect of the invention, there is provided a molecularly imprinted polymer suitable for the detection of a target molecule, the polymer comprising a crosslinked polymer with a plurality of cavities, where:

the polymer is formed from a functional monomer selected from one or more of the group consisting of methacrylic acid, methyacrylamide, and methyl methacrylate and a crosslinking agent selected ethylene glycol dimethacrylate and/or trimethylolpropane trimethacrylate;

the cavities have a first affinity for a surrogate molecule and a second affinity for the target molecule, where the first affinity is greater than or equal to the second affinity, wherein the molecularly imprinted polymer has:

a binding capacity for the target molecule that is at least 60% of the binding capacity obtained from a molecularly imprinted polymer produced using the target molecule itself; and

a binding capacity for the target molecule that is from 10 to 30 μmol/g.

The second aspect of the invention may also be described as a molecularly imprinted polymer suitable for the detection of a target molecule, the polymer formed from:

a functional monomer selected from one or more of the group consisting of methacrylic acid, methyacrylamide, and methyl methacrylate;

a crosslinking agent selected ethylene glycol dimethacrylate and/or trimethylolpropane trimethacrylate; and

a surrogate molecule used to form cavities in the polymer that have an affinity for the target molecule, wherein the molecularly imprinted polymer has:

a binding capacity for the target molecule that is at least 60% of the binding capacity obtained from a molecularly imprinted polymer produced using the target molecule itself;

a binding capacity for the target molecule that is from 10 to 30 μmol/g.

It is noted that the MIPs are extremely stable and may be reused multiple times, in either the preconcentration step or in the detecting steps discussed below.

The functional molecule(s), crosslinking agent(s) and surrogate molecules are as defined above. The ratios of the functional molecule(s) to crosslinking agent(s) may also be as defined hereinbefore. In addition, the binding efficiencies of the MIPs for the target molecule may be as discussed hereinbefore (e.g. at least 2).

The defining feature of the MIPs of the current invention is the cavities left by the surrogate molecule used to form the MIPs. Given this, it will be appreciated that the MIPs are substantially free of the surrogate molecule. The MIPs may be used as-is in the detection of the target molecule or used in a pre-concentrating material as discussed below.

As will be understood, the MIPs used herein have a plurality of cavities that are generated by the use of a surrogate molecule by the methods described above. As will be apparent, the affinity (e.g. binding capacity and/or binding efficiency) of the MIP to the surrogate molecule will be greater than or equal to (i.e. greater than), the affinity of the MIP to the target molecule.

In particular embodiments of the invention, the MIPs may further comprise a fluorescently-labelled surrogate of the target molecule, where said surrogate is a weaker binder than the target molecule, such that it is displaced from the polymer upon exposure of the polymer to the target molecule. It will be appreciated that the fluorescently-labelled surrogate of the target molecule is disposed within the cavities of the MIP. This arrangement is particularly advantageous because it allows for the qualitative and/or quantitative detection of the target molecule in an analyte through the detection of fluorescence. In addition, the combined MIP and fluorescently-tagged surrogate disposed within the cavities of the MIP may exhibit excellent stability properties. For example, the combined material may be stable for over one month. In addition, it will be appreciated that as the underlying MIP material is very stable, it is possible to regenerate the combined material after use. For example, this regeneration may be accomplished by performing an extraction step to remove bound materials followed by reintroduction of the fluorescently-tagged surrogate.

As noted above, the target molecule may be geosmin. In such cases, the MIP may have a binding capacity of from 10 to 15 μmol/g, such as 11.6 μmol/g for geosmin. An MIP that may be suitable for the binding of geosmin that may be mentioned herein may be one in which the functional monomer is methacrylic acid, the crosslinking agent is trimethylolpropane trimethacrylate and the ratio of functional monomer:crosslinking agent is 1:1. The resulting MIP may be particularly useful in the preconcentration of geosmin prior to detection. To enable quantitative and/or qualitative detection, the MIP may be loaded with a fluorescently-labelled surrogate of geosmin where the surrogate is a weaker binder than geosmin, such that it is displaced from the polymer upon exposure of the polymer to geosmin. An example of a suitable fluorescently-labelled surrogate of geosmin is [(4aS,8aS)-decalin-1-yl]-2-(7-amino-4-methyl-2-oxo-chromen-3-yl)acetate.

As noted above, the target molecule may be 2-methylisoborneol. In such cases, the MIP may have a binding capacity of from 15 to 20 μmol/g, such as 18.9 μmol/g for 2-methylisoborneol. An MIP that may be suitable for the binding of 2-methylisoborneol that may be mentioned herein may be one in which the functional monomer is methacrylic acid, the crosslinking agent is ethylene glycol dimethacrylate and the ratio of functional monomer:crosslinking agent is 1:2.5. The resulting MIP may be particularly useful in the preconcentration of 2-methylisoborneol prior to detection. To enable quantitative and/or qualitative detection, the MIP may be loaded with a fluorescently-labelled surrogate of 2-methylisoborneol where the surrogate is a weaker binder than 2-methylisoborneol, such that it is displaced from the polymer upon exposure of the polymer to 2-methylisoborneol. An example of a suitable fluorescently-labelled surrogate of 2-methylisoborneol is cyclohexyl-2-(7-amino-4-methyl-2-oxo-chromen-3-yl)acetate.

As noted above, the MIPs produced herein may be especially useful in detecting the presence of a target molecule even when the target molecule is only found in minute quantities in a sample. This may be particularly useful for detecting the presence of microbial entities that may pose a health and/or environmental risk to a body of water. Thus in a further aspect of the invention, there is provided a method of detecting the concentration of a target molecule in a sample with a molecularly imprinted polymer, wherein the method comprises the steps of:

(a) providing a molecularly imprinted polymer comprising a fluorescently-labelled surrogate of the target molecule as described above and a sample for analysis;
(b) contacting the molecularly imprinted polymer with the sample for a period of time to form a sample-polymer mixture;
(c) separating the sample-polymer mixture to provide a contacted sample; and
(d) qualitatively detecting the presence of the target molecule in the contacted sample by observing the presence of fluorescence in the contacted sample or quantitatively determining the concentration of the target molecule in the contacted sample by measuring the fluorescence in the contacted sample using a fluorescence spectrometer.

The use of the MIB and fluorescent surrogate may be perfectly useable in many situations, as the sensitivity of the method may be in the parts per billion range already. For example, when the target molecule is geosmin the selected MIP may have a limit of detection of from 60 to 80 ppb, while when the target molecule is 2-methylisoborneol the selected MIP may have a limit of detection of from 40 to 60 ppb.

In order to further improve the detection capabilities, it is possible to include a preconcentration step into the method. For example, before step (b) of the detection method, the sample may be subjected to a preconcentration process that comprises the steps of:

(i) contacting the sample with a preconcentration material to capture at least the target molecule;
(ii) subsequently releasing the target molecule from the preconcentration material to provide a preconcentrated sample that is then used in steps (b) to (d) of the detection method.

Any material that can be used to capture the target molecule and then release it may be used as the preconcentration material. For example, the preconcentration material may be a reverse phase material (e.g. a C₁₆-C₁₈ reverse phase material) or it may be the MIP without the fluorescent surrogate molecule as described above. When a preconcentration step is used in the method, the resulting limit of detection may be lowered by more than an order of magnitude, for example the limit of detection may be in the parts per trillion range (ppt). In embodiments of the invention where the target molecule is geosmin the selected MIP may have a limit of detection with preconcentration step of around 20 ppt. In other embodiments, when the target molecule is 2-methylisoborneol the selected MIP may have a limit of detection with preconcentration of around 14 ppt.

Further details of the detection method with and without preconcentration step are provided in the following examples.

As mentioned above, it is possible to form a device that incorporates the MIPs made herein. Such a device may be used to detect a target molecule qualitatively and/or quantitatively in a sample for analysis, where the device comprises:

a preconcentration section to receive a sample and capture at least the target molecule on a preconcentration material;

a preconcentration sample section to receive a preconcentrated sample from the preconcentration section; and

a detection section that receives the preconcentrated sample and qualtatively and/or quantitatively detects the target molecule, wherein:

the detection section comprises a molecularly imprinted polymer comprising a fluorescent surrogate molecule as described above.

The preconcentration material may be as defined hereinbefore. The device may be in a single unified structure or may be a kit of parts.

Non-limiting examples which embody certain aspects of the invention will now be described.

### EXAMPLES

Materials and Methods

Cis-Decahydro-1-naphthol, 1-bromoadamantane, methacrylic acid (MAA), methacrylamide (MAD), methyl methacrylate (MMA), ethylene glycol dimethacrylate (EGDMA), trimethylolpropane trimethacrylate (TRIM), (±)geosmin (GSM) standard and 2-methylisoborneol (2-MIB) standard, 7-amino-4-methyl-3-coumarinylacetic acid, and cyclohexanol were purchased from Sigma-Aldrich (USA), and 2,2-azoisobutyronitrile (AIBN) from Sinopharm Chemical Reagent Co. Ltd. (Singapore). N-(3-dimethylaminopropyl)-N-ethylcarbodiimide hydrochloride (EDC.HCl) and diisopropylethylamine were obtained from Tokyo Chemical Industry Co., Ltd. (TCI). N,N-Dimethylaminopyridine was obtained from Alfa Aeser. Anhydrous DMF was obtained using Innovative Technology Pure-Solv solvent purification system. All the solvents were HPLC grade and purchased from Sigma Aldrich (USA) and used without further purification.

Thin layer chromatography (TLC) was performed on Merck pre-coated silica gel plates. The TLC plates were visualised under UV light or by staining with KMnO₄ solution. Compounds were purified by flash chromatography on columns using Merck silica gel 60 (230-400 mesh) unless otherwise specified. Mass spectra were recorded on a Shimadzu Nexera-X2 HPLC system coupled to a Shimadzu LCMS-2020 mass spectrometer. NMR spectra were recorded at 400 MHz for ¹H and at 100 MHz for ¹³C on a Bruker spectrometer with CDCl₃ or DMSO-d₆ as solvent. The chemical shifts are given in ppm, using the proton solvent residue signal (CDCl₃: δ=7.26; DMSO-d₆: δ=2.50) as a reference in the ¹H NMR spectrum. The deuterium coupled signal of the solvent was used as reference in ¹³C NMR (CDCl₃: δ=77.0; DMSO-d₆: δ=39.5). The following abbreviations were used to describe the signals: s=singlets, d=doublet, t=triplet, m=multiplet, br=broad signal.

GC-MS analysis was carried out using an Agilent 7890A GC with 5979C inert MSD. The GC column was an Agilent DB5-MS (30 m×0.25 mm×0.25 μM). Helium was used as carrier gas at a flow rate of 1 mL min⁻¹ under splitless mode. The GC program for GSM was as follows: 80° C. for 1 min, 5° C. min⁻¹ to 100° C., 15° C. min⁻¹ to 280° C. The GC program for 2-MIB was as follows: 40° C. for 3 min, 10° C. min⁻¹ to 160° C., 20° C. min⁻¹ to 280° C., hold 2 min. The MS was operated in scan or selected ion monitoring (SIM) mode. Acquisition was performed in scan mode from 50 to 800 amu. For SIM mode, electron ionization (electron accelerating voltage: 70 V) was used. The following target m/z ratios were used for quantification with the other m/z ratios were used for analyte confirmation: MIB: 95 (target ion), 107, 108, 135. Fluorescence measurements were performed on Cary Eclipse fluorescence Spectrophotometer (Agilent Technologies).

### Example 1

Synthesis of MIP-GSMS and MIP-MIBS Using the Selected Surrogate Templates

Surrogate Template Selection

Although GSM and 2-MIB are commercially available, both compounds are prohibitively expensive to be used as templates in the synthesis of their respective MIPs. This is not practical when a large amount of these compounds would be needed to synthesise the MIPs for large scale applications. As such, a shape-based screening tool was used to screen the Maybridge, ChemBridge and Asinex databases against a shape query (GSM and 2-MIB) in which the shape similarity search approach identified similar compounds in terms of their shape as well as their atom types. All Calculations were carried out using Schrödinger software (Schrödinger Release 2015-1 Maestro, version 10.1, Schrödinger. LLC, New York, 2015). The main criteria in selecting the surrogate templates for the MIP synthesis were based on their commercial availability, cost and having a high shape similarity score. From these screens, surrogate templates for each of GSM (cis-decahydro-1-naphthol) and 2-MIB (1-bromoadamantane) were selected respectively, which both gave shape similarity scores of 0.85. FIG. 2 depicts the chemical structures of GSM (1) and 2-MIB (2), as well as their respective surrogate templates 3 and 4.

The MIPs that were synthesised using the GSM surrogate template were named MIP-GSMS, while those synthesised using the 2-MIB surrogate template were named as MIP-MIBS.

Synthesis of MIP-GSMS and MIP-MIBS

A combinatorial library of MIP-GSMS AND MIP-MIBS were synthesised by varying and optimising the composition of the reactants, such as different functional monomers, cross-linkers, and template-to-functional and monomer-to-cross-linker mole ratios. In these studies, the choice of functional monomer (FM) to make the polymers were methacrylic acid (MAA), methacrylamide (MAM) or methyl methacrylate (MMA), while the cross-linkers (CL) was either ethylene glycol dimethacrylate (EGDMA) or trimethylolpropane trimethacrylate (TRIM). The carboxylic acid functional group of the acidic functional monomer MAA was considered to possess excellent hydrogen bond donor-acceptor capabilities that could participate in hydrogen bonding interactions with the template, cis-decahydro-1-naphthol.

Typically, the template and functional monomer were dissolved in acetonitrile in a 100-mL round bottom flask followed by the crosslinker and 30 mg of the initiator AIBN. The mixture was sonicated in an ultrasonicator bath until a clear solution was obtained. This mixture was kept at 0° C. for 10 min, purged with a gentle flow of nitrogen and sealed under the nitrogen atmosphere. The flask was kept in an oil bath with mild stirring. The temperature was ramped from room temperature to 60° C. over a period of 1 h and then kept constant at this temperature for 24 h. After polymerisation, the polymer particles were collected by centrifugation. The MIPs were washed using methanol:acetic acid (9:1 v/v) in a Soxhlet extractor to remove the template from its polymeric matrix. The MIPs were washed till no further desorption of the template was detected using GC-MS. The MIPs were then washed three times with chloroform. The synthetic protocol was repeated for different combinations of the functional monomer and crosslinkers, using either cis-decahydro-1-naphthol or 1-bromoadamantane as surrogate templates, in various mole ratios.

The sample labels are abbreviated as follows: Molecular Imprinted Polymer-GSM or 2-MIB surrogate/Functional Monomer/Crosslinker (conditions number), for example, MIP-GSMS/MAA/TRIM1.

The non-imprinted polymers (NIPs) were synthesised using identical conditions mentioned above, but without the surrogate templates. NIPs particles were collected after polymerisation by centrifugation and washed with chloroform to remove the unreacted precursors. Finally, all polymers were dried at 70° C. in a hot air oven and stored at room temperature for further experiments and characterisation.

Table 1 lists the combinatorial preparation parameters for different MIP-GSMS and the corresponding NIPs using cis-decahydro-1-naphthol (3) as the surrogate template.

Table 2 lists the preparation for different MIP-MIBS and the corresponding NIPs using 1-bromoadamantane (4) as the surrogate template.

TABLE 1
Combinatorial preparation of MIP-GSMS and the corresponding NIP.

| | Template | | |
|---|---|---|---|
| | (cis-decahydro- | Functional | |
| | 1-naphthol) | Monomer | Cross linker |
| Polymer^{a} | (mmol) | (mmol) | (mmol) |
| MIP-GSMS/MAA/EGDMA1 | 0.6 | MAA, 1.2 | EGDMA, 3 |
| (T:FM:CL = 1:2:5) | | | |
| MIP-GSMS/MAA/EGDMA2 | 0.3 | MAA, 1.2 | EGDMA, 3 |
| (T:FM:CL = 1:4:10) | | | |
| MIP-GSMS/MAA/EGDMA3 | 0.2 | MAA, 1.2 | EGDMA, 3 |
| (T:FM:CL = 1:6:15) | | | |
| NIP-MAA/EGDMA1 | — | MAA, 1.2 | EGDMA, 3 |
| (FM:CL = 1:2.5) | | | |
| MIP-GSMS/MAA/TRIM1 | 0.6 | MAA, 1.2 | TRIM, 1.2 |
| (T:FM:CL = 1:2:2) | | | |
| MIP-GSMS/MAA/TRIM2 | 0.3 | MAA, 1.2 | TRIM, 1.2 |
| (T:FM:CL = 1:4:4) | | | |
| MIP-GSMS/MAA/TRIM3 | 0.2 | MAA, 1.2 | TRIM, 1.2 |
| (T:FM:CL = 1:6:6) | | | |
| NIP-MAA/TRIM2 | — | MAA, 1.2 | TRIM, 1.2 |
| (FM:CL = 1:1) | | | |
| MIP-GSMS/MAD/EGDMA1 | 0.6 | MAD, 1.2 | EGDMA, 3 |
| (T:FM:CL = 1:2:5) | | | |
| MIP-GSMS/MAD/EGDMA2 | 0.3 | MAD, 1.2 | EGDMA, 3 |
| (T:FM:CL = 1:4:10) | | | |
| MIP-GSMS/MAD/EGDMA3 | 0.2 | MAD, 1.2 | EGDMA, 3 |
| (T:FM:CL = 1:6:15) | | | |
| NIP-MAD/EGDMA3 | — | MAD, 1.2 | EGDMA, 3 |
| (F:CL = 1:2.5) | | | |
| MIP-GSMS/MAD/TRIM1 | 0.6 | MAD, 1.2 | TRIM, 1.2 |
| (T:FM:CL = 1:2:2) | | | |
| MIP-GSMS/MAD/TRIM2 | 0.3 | MAD, 1.2 | TRIM, 1.2 |
| (T:FM:CL = 1:4:4) | | | |
| MIP-GSMS/MAD/TRIM3 | 0.2 | MAD, 1.2 | TRIM, 1.2 |
| (T:F:CL = 1:6:6) | | | |
| NIP-MAD/TRIM4 | — | MAD, 1.2 | TRIM, 1.2 |
| (FM:CL = 1:1) | | | |
| MIP-GSMS/MMA/EGDMA1 | 0.6 | MMA, 1.2 | EGDMA, 3 |
| (T:FM:CL = 1:2:5) | | | |
| MIP-GSMS/MMA/EGDMA2 | 0.3 | MMA, 1.2 | EGDMA, 3 |
| (T:FM:CL = 1:4:10) | | | |
| MIP-GSMS/MMA/EGDMA3 | 0.2 | MMA, 1.2 | EGDMA, 3 |
| (T:FM:CL = 1:6:15) | | | |
| NIP-MMA/EGDMA5 | — | MMA, 1.2 | TRIM, 1.2 |
| MIP-GSMS/MMA/TRIM1 | 0.6 | MMA, 1.2 | TRIM, 1.2 |
| (T:FM:CL = 1:2:2) | | | |
| MIP-GSMS/MMA/TRIM2 | 0.3 | MMA, 1.2 | TRIM, 1.2 |
| (T:FM:CL = 1:4:4) | | | |
| MIP-GSMS/MMA/TRIM3 | 0.2 | MMA, 1.2 | TRIM, 1.2 |
| (T:FM:CL = 1:6:6) | | | |
| NIP-MMA/TRIM6 | — | MMA, 1.2 | TRIM, 1.2 |
| (FM:CL = 1:1) | | | |

^{a}Various microspheric polymers were synthesised. MIP-molecular imprinted polymer; NIP-non-molecular imprinted polymer; T: Template; FM: Functional Monomer; CL: cross-linker; MAA-methacrylic acid; MAD-methacrylamide; MMA-methyl methacrylate; EGDMA-ethylene glycol dimethacrylate; TRIM-trimethylolpropane trimethacrylate.

TABLE 2
Combinatorial preparation of MIP-MIBS and the corresponding NIP.

| | Template | Functional | Cross |
|---|---|---|---|
| | (1-bromoadamantane) | Monomer | linker |
| Polymer | (mmol) | (mmol) | (mmol) |
| MIP-MIBS/ | 0.6 | MAA, 1.2 | EGDMA, 3 |
| MAA/EGDMA1 | | | |
| (T:FM:CL = 1:2:5) | | | |
| MIP-MIBS/ | 0.3 | MAA, 1.2 | EGDMA, 3 |
| MAA/EGDMA2 | | | |
| (T:FM:CL = 1:4:10) | | | |
| MIP-MIBS/ | 0.2 | MAA, 1.2 | EGDMA, 3 |
| MAA/EGDMA3 | | | |
| (T:FM:CL = 1:6:15) | | | |
| NIP-MAA/EGDMA1 | — | MAA, 1.2 | EGDMA, 3 |
| (FM:CL = 1:2.5) | | | |
| MIP-MIBS/ | 0.6 | MAA, 1.2 | TRIM, 1.2 |
| MAA/TRIM1 | | | |
| (T:FM:CL = 1:2:2) | | | |
| MIP-MIBS/ | 0.3 | MAA, 1.2 | TRIM, 1.2 |
| MAA/TRIM2 | | | |
| (T:FM:CL = 1:4:4) | | | |
| MIP-MIBS/ | 0.2 | MAA, 1.2 | TRIM, 1.2 |
| MAA/TRIM3 | | | |
| (T:FM:CL = 1:6:6) | | | |
| NIP-MAA/TRIM2 | — | MAA, 1.2 | TRIM, 1.2 |
| (FM:CL = 1:1) | | | |

### Example 2. Determining the Binding Efficiency and Binding Capacity of MIP-GSMS and MIP-MIBS

The binding experiments of MIPs with GSM and 2-MIB were carried out batch-wise in triplicate to study the recognition performance of the MIPs in aqueous solutions for the methods given below.

Kinetic Study to Determine the Optimised Incubation Time

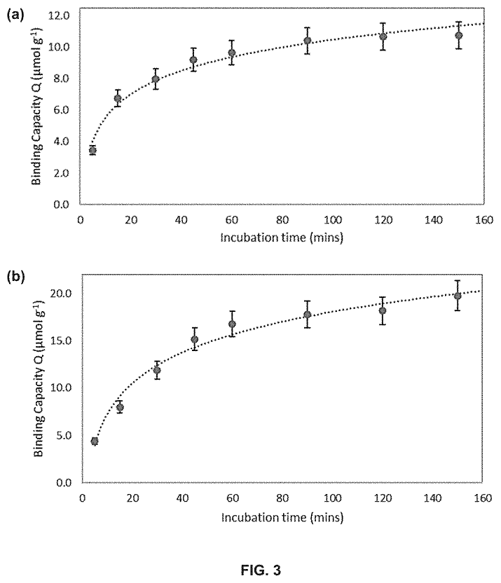

The contact time was studied by equilibrating 15 mg of MIP-GSMS/MAA/TRIM2 with 1.37 mmol L⁻¹ of the GSM or 15 mg of MIP-MIBS/MAA/EDGMA2 with 1.37 mmol L⁻¹ of the 2-MIB solutions for fixed time periods from 30 min up to 10 h. The mixtures were centrifuged and the supernatants were analysed for GSM or 2-MIB using GC-MS. The binding capacity of the MIP with GSM or 2-MIB was calculated and the optimised incubation time period was determined. It was observed that the binding equilibrium was reached after 1 h for both MIP-GSMS/MAA/TRIM2 and MIP-MIBS/MAA/EDGMA2 (FIGS. 3a and 3b respectively). Given this, the optimum binding duration was determined to be 1 h.

Binding Capacity Study

1.37 mmol L⁻¹ GSM or 2-MIB solution were prepared from the standard solution. 1 mL aliquots of each standard solution were mixed with 15 mg of the polymer and shaken for 1 h. The mixtures were then centrifuged and the supernatants were analysed for GSM or 2-MIB using GC-MS.

The binding capacity, Q (μmol g⁻¹) of the MIPs and NIPs was calculated using Eq. (1):

Q=[(Cᵢₙᵢₜₐₗ−C_{final})×Vₛₒₗᵤₜᵢₒₙ]/W (1)

where Cᵢₙᵢₜₐₗ and C_{final} are the initial and final concentrations of the GSM solution, respectively. Vₛₒₗᵤₜᵢₒₙ is the volume of GSM solution and W is the weight of the polymer.

The adsorption isotherm of MIP-GSMS/MAA/TRIM2 and NIP-MAA/TRIM2 indicated that the former had a higher binding capacity for GSM as compared to the corresponding NIP. The experimental maximum adsorption capacities were calculated to be 11.6 μmol g⁻¹ for MIP-GSMS/MAA/TRIM2 and 5.7 μmol g⁻¹ for the corresponding NIP, respectively. This implies that molecular recognition sites were generated on the MIP-GSMS by the template during the polymerisation process, therefore allowing the MIP-GSMS to bind specifically to GSM.

Determining the Best Performing MIPs

The best MIP-GSMS and MIP-MIBS were selected based on their binding efficiency as well as the binding capacities for the respective analytes and/or the surrogate. To establish the binding efficiency (Q_{MIP}/Q_{NIP}) of the MIP-GSMS and MIP-MIBS for the respective analytes and/or surrogate, the ratios of the binding capacity of MIP-GSMS to that of the NIP, under the same incubation conditions, were determined.

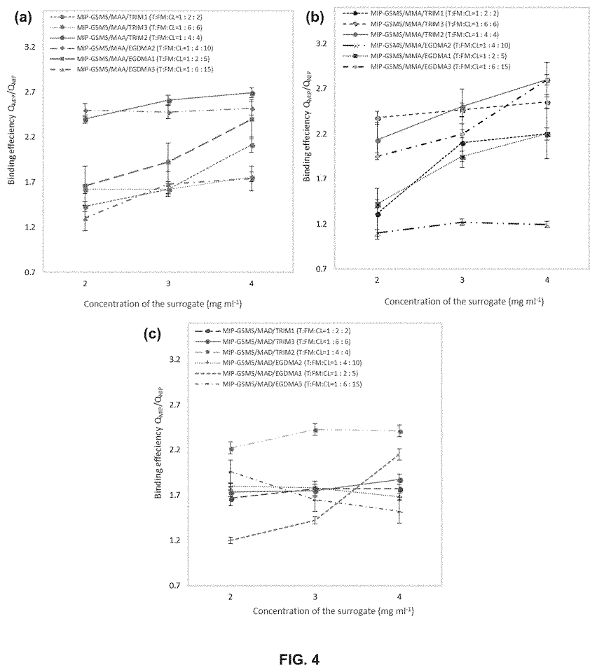

FIG. 4a-c show the binding efficiency (Q_{MIP}/Q_{NIP}) for the entire library of polymers for the surrogate molecule (cis-decahydro-1-naphthol). As shown in FIG. 4a-c, a number of the MIPS demonstrated a reasonable binding efficiency of from 2 to 3 for the surrogate (the full binding efficiency range was from around 1.1 to 2.8). The best of these MIP-GSMS/MAA/TRIM2 (Template:FM:CL=1:4:4, where MAA is the FM and TRIM is the CL) was considered the most promising from this initial screen and was selected for further analysis.

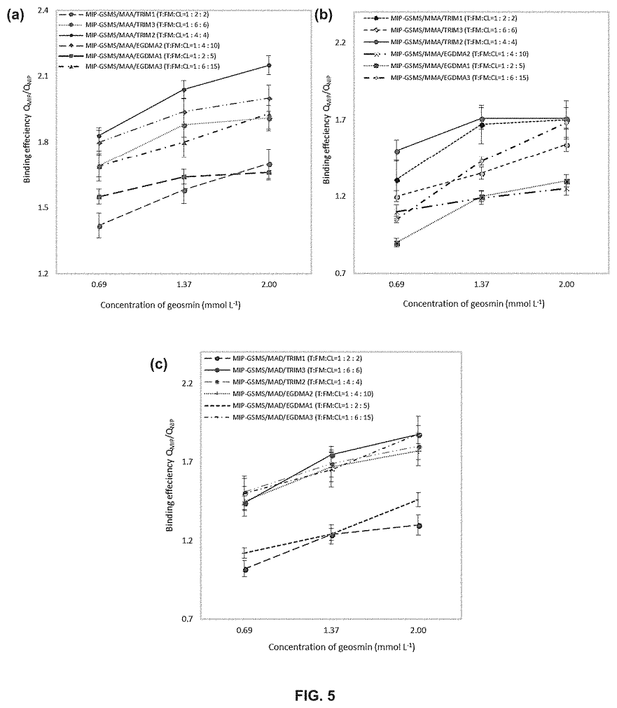

In order to further confirm that the selection of MIP-GSMS/MAA/TRIM2 was indeed correct, the protocol described above was run again, this time using geosmin instead of the surrogate molecule. As expected, as shown in FIGS. 5a-c the binding efficiency for geosmin was less than the binding efficiency for the surrogate molecule (full binding efficiency range of from 0.9 to 2.15), but these results demonstrated that MIP-GSMS/MAA/TRIM2 was still the best polymer from those obtained. Most importantly, the best polymer was chosen based on having the highest binding efficiency for the target molecule instead of the surrogate molecule.

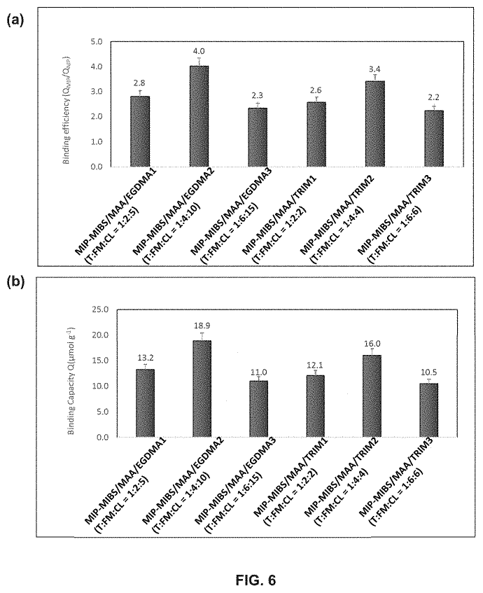

The binding capacity and binding efficiency of MIPs-MIB with 2-MIB (the target) as analyte were also obtained. The MIPs-MIB binding efficiencies (Q_{MIP}/Q_{NIP}), ranged from 2.2 to 4.0, were measured relative to the corresponding NIPs. This signified selective binding of 2-MIB on the imprinted sites of MIPs-MIB. As a result, MIP-MIBS/MAA/EGDMA2 (T:FM:CL=1:4:10) was selected as the best MIP due to its higher binding capacity (18.9 μmol g⁻¹) and binding efficiency (i.e. 4) with 2-MIB (FIGS. 6a and b).

### Example 3. Characterisation of MIP-GSMS/MAA/TRIM2 and NIP-MAA/TRIM2 Using Field Emission Scanning Electron Microscopy (FESEM)

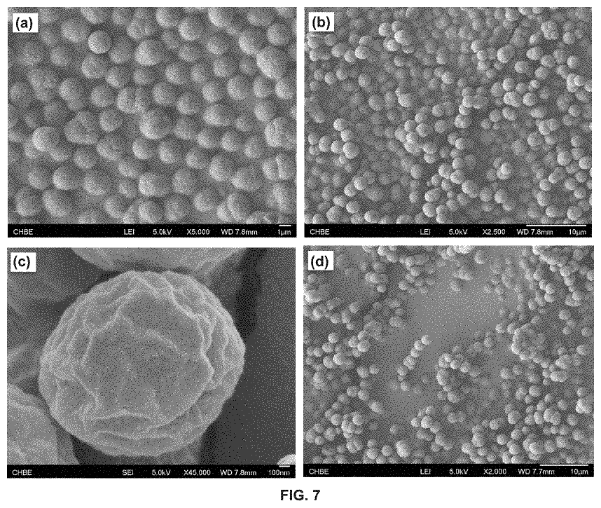

The polymer samples were coated with a thin gold film before they were analysed via a FESEM (JEOL JSM-6700F) at 5.0 kV. The morphology of the MIP-GSMS/MAA/TRIM2 was as shown in FIG. 7a-c at various magnifications. In comparison to the morphology of NIP-MAA/TRIM2 (FIG. 7d), both MIP-GSMS/MAA/TRIM2 and NIP-MAA/TRIM2 appear as uniform spherical particles. In addition, the size of MIP-GSMS/MAA/TRIM2 was almost the same as that of NIP-MAA/TRIM2, which was 2 μm in diameter.

### Example 4. Characterisation of MIP-GSMS/MAA/TRIM2 and NIP-MAA/TRIM2 Using Fourier-Transform Infrared (FTIR) Spectroscopy

To further characterise the MIP-GSMS, the FT-IR spectra of the MIP-GSMS/MAA/TRIM2 and the corresponding NIP-MAA/TRIM2 were compared as shown in FIG. 8. The FT-IR spectra of the polymers were recorded using a FT-IR spectrometer (IR-Affinity-1, Shimadzu). The samples were ground with anhydrous KBr and analysed in a form of a KBr pellet. Each spectrum was obtained from an average of 45 scans and was recorded between 4000 and 400 cm⁻¹.

The FT-IR spectra of the MIP-GSMS/MAA/TRIM2 before and after removal of the template are shown in FIGS. 8a and b, respectively. A broad band at 3580 cm⁻¹ due to the —OH stretching vibration of MAA can be observed from the FT-IR spectra of MIP-GSMS/MAA/TRIM2 before removal of the template from its matrix (FIG. 8a), while a —OH stretching vibration at 3610 cm′ was observed after the template was removed (FIG. 8b). The appearance of a broad band at a lower vibrational frequency before template removal appears to suggest that the template cis-decahydro-1-naphthol might be bonded to the functionalities of the polymer via hydrogen bonding. This band was shifted to a higher value (at 3610 cm⁻¹) after removal of the template in MIP-GSMS/MAA/TRIM2 (FIG. 8b). The peak at 3612 cm⁻¹ in FIG. 8c corresponds to the —OH stretching of MAA in NIP-MAA/TRIM2. The shift in vibrational frequency to the lower wavenumber for the —OH stretch was not observed for NIP-MAA/TRIM2 due to the absence of the template in its matrix.

The other important bands observed in the spectra of MIPs before and after the template removal and in the spectra of NIPs were: carbonyl stretching (1739 cm⁻¹), —C—O stretching (1161 cm⁻¹) and symmetric and asymmetric C—H stretching due to the methyl groups in the polymer network (peaks at 2978 cm⁻¹, 1473 cm⁻¹, 1392 cm⁻¹ and 975 cm⁻¹). The similarity in the MIPs and NIPs backbone is due to the incorporation of the cross-linker TRIM.

### Example 5. Morphological Characterisation of MIP-GSMS/MAA/TRIM2 and NIP-MAA/TRIM2 by the Brunauer-Emmett-Teller (BET) Method

The surface area, total pore volume, and average pore diameter were analysed by the Brunauer-Emmett-Teller (BET) method on Micromeritics ASAP-2020. The samples were degassed for 4 h at 100° C. before analysis.

BET surface area characterisation showed that MIP-GSMS/MAA/TRIM2 and NIP-MAA/TRIM2 have surface areas of 110.34 m² g⁻¹ and 86.22 m² g⁻¹, respectively. These results showed that molecular imprinting molecules significantly improved the surface area. Additionally, a larger pore volume and pore surface area of MIPs was observed as compared to NIPs. Both MIPs and NIPs showed uniform micropores with an average diameter of 2.78 nm and 2.50 nm, respectively and the pore volumes were estimated to be 3.39 m³ g⁻¹ and 2.82 m³ g⁻¹, respectively.

To determine the extent of swelling of the polymers in water, 50 mg of the dry polymer was suspended in 1.5 mL of distilled water in a microtube and mixed vigorously for 2 min followed by equilibration for 5 h. The final weight of the wet sample was measured after filtering out the excess of the solvent. This procedure was repeated thrice and percent swelling ratio was calculated using the equation below:

Swelling(%)=(Wₛ−W_{d})/W_{d}×100 (2)

where W_{d}=Weight of polymer Wₛ=weight of swollen polymer

The percentage swelling ratio of MIP-GSMS/MAA/TRIM2 and NIP-MAA/TRIM2 in water was 5% and 6% respectively. This swelling capacity demonstrated a moderate crosslinking in MIPs which was advantageous for the binding with GSM.

As will be appreciated, the swelling ratio may also be measured by reference to the original and resulting volume of the polymer. With this in mind, MIP-MAATRIM2 (Template:FM:CL=1:4:4) and NIP-MAATRIM's (FM:CL=1:1) had a swelling ratio (by volume) in water of 73% and 83%, respectively. This was calculated by the following formula:

Volume swell ratio(%)=Volume of the dry polymer/Volume of the swollen polymer×100

The swelling of the MIPs polymeric matrix may modify the shape of imprinted cavities and thus the binding capacity and performance of MIPs-GSM. A moderate swelling in MIPs-GSM, however, was advantageous for the geosmin extraction protocol.

### Example 6. Cross-Selectivity Studies with MIP-GSMS/MAA/TRIM2 and MIP-MIBS/MAA/EGDMA2

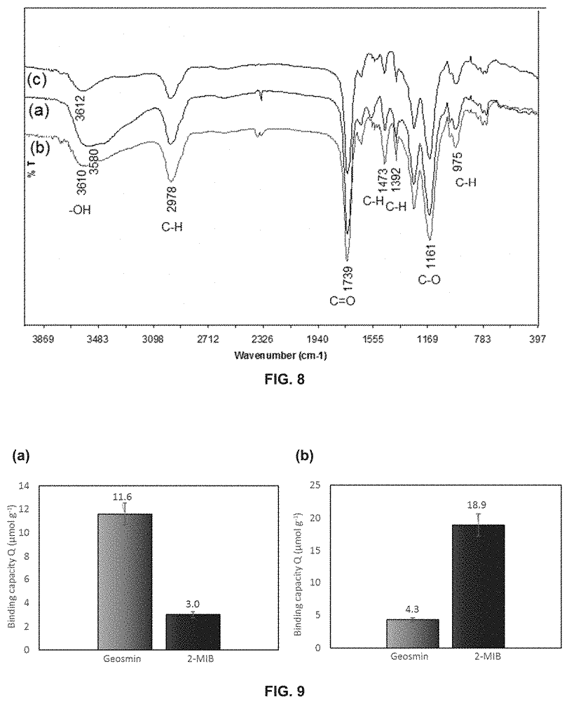

The fidelity of the imprinting process was assessed by evaluating the cross-selectivity of MIP-GSMS/MAA/TRIM2 and MIP-MIBS/MAA/EGDMA2 for GSM and MIB. As shown in FIG. 9a, MIP-GSMS/MAA/TRIM2 exhibited a higher specific binding capacity for GSM than 2-MIB, with a selectivity factor of 3.9 for GSM over MIB in terms of their binding capacities. The high selectivity is due to the presence of template-imprinted cavities with size, shape and stereochemistry that were specific to GSM. When MIP-MIBS/MAA/EGDMA2 was used, a selectivity factor of 4.3 for MIB over GSM was obtained (FIG. 9b). These studies show that the template imprinting process can indeed differentiate between two different organic compounds, based on the different templates used.

### Example 7. Synthesis of MIP-GSM Using Authentic Geosmin as a Template

As a comparative study, MIP-GSM using authentic GSM as a template was synthesised via the same protocols as outlined in Example 1. The functional monomer in this case was MAA and the cross-linker was TRIM. The molar ratio of GSM, functional monomer and cross linker was kept at 1:4:4, similar to that using GSM surrogate as template. This MIP-GSM/MAA/TRIM achieved higher selective adsorption and binding efficiency as compared with MIP-GSMS/MAA/TRIM2 synthesised using a GSM surrogate. The binding capacity of the MIP-GSM/MAA/TRIM was 17.5 μmol g⁻¹, whereas that of MIP-GSMS/MAA/TRIM2 was 11.6 μmol g⁻¹. Although the use of GSM as a template is impracticable on a large scale, this study demonstrated that the binding efficiency of MIP for GSM can be further improved when the actual analyte was used as a template for synthesising the MIP.

### Example 8. Detection of GSM Using MIP-GSMS/MAA/TRIM2 and a Fluorescent Tag 6

The concept behind detecting analytes of interest using the MIP is as shown in FIG. 1. After removing the template from the as-synthesised MIP, a fluorescent tag of the analyte analogue can be added to bind to the cavities. In the presence of the analytes, the fluorescent tags are then displaced by the analytes from the cavities. In this approach, the tagged analogue should be a weaker binder than the analyte itself, therefore, there should not be any interference by the tagged analogues. The amount of fluorescent tags in the solution can be quantified using fluorescence spectroscopy and the fluorescence intensities are correlated directly with the amount of analytes in the sample.

Synthesis of Decahydronaphthalen-1-Yl 2-(7-Amino-4-Methyl-2-Oxo-2H-Chromen-3-Yl) Acetate) (6)

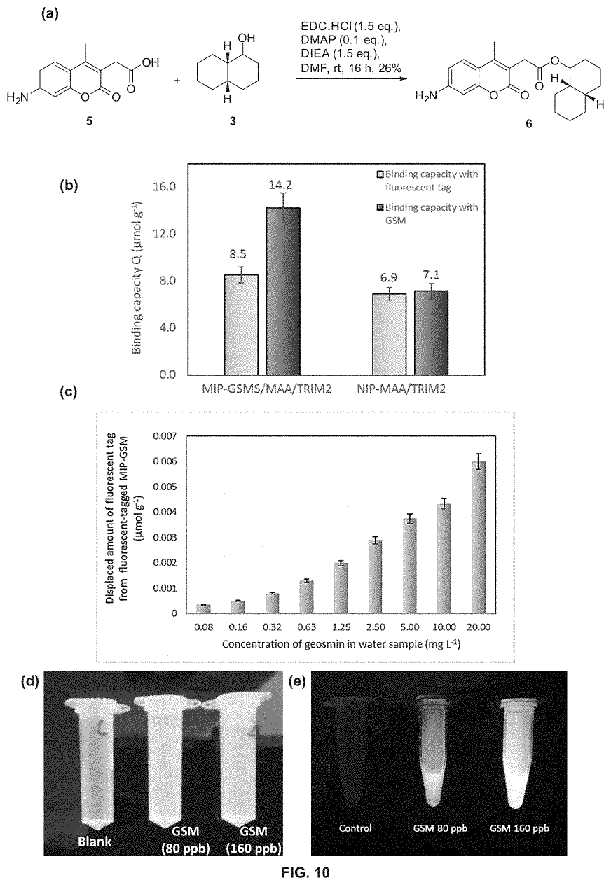

Using the principles as outlined above, a fluorescent tag of a GSM analogue was first synthesised by conjugating a fluorescent molecule, 7-amino-4-methyl-3-coumaric acid (5), with cis-decahydro-1-naphthol (3) (FIG. 10a).

DIEA (84 mg, 0.65 mmol) was added to a solution of acid 5 (100 mg, 0.43 mmol), cis-decahydro-1-naphthol (3) (80 mg, 0.52 mmol), EDC.HCl (125 mg, 0.65 mol) and DMAP (5 mg, 0.043 mmol) in DMF (3 mL). The reaction mixture was stirred at room temperature for 16 h. The reaction mixture was diluted with water (20 mL), the aqueous layer was extracted with EtOAc (3×10 mL). The combined organic phase was washed with brine, dried over anhydrous Na₂SO₄ and concentrated under reduced pressure. The residue was purified by flash chromatography (PE/EtOAc, 7:3) to give conjugate 6 (40.9 mg, 26%) as white solid. ¹H NMR (400 MHz, CDCl₃) δ 7.39 (d, J=8.0 Hz, 1H), 6.57 (dd, J=8.4, 2.4 Hz, 1H), 6.54 (d, J=2.4 Hz, 1H), 4.81 (dt, J=11.6, 5.2 Hz, 1H), 4.11 (br s, 2H), 3.55 (s, 2H), 2.32 (s, 3H), 1.96-2.01 (m, 1H), 1.15-1.79 (m, 15H); ¹³C NMR (100 MHz, CDCl₃) δ 170.1, 162.1, 154.4, 149.7, 149.2, 125.9, 115.0, 112.0, 111.8, 101.1, 39.9, 35.5, 33.1, 31.5, 26.0, 25.9, 21.4, 15.2; ESI-MS: (m/z) 370.1 calcd for C₂₂H₂₇NO₄ [M+H]⁺, found 370.2.

Binding Capacity of MIP-GSMS/MAA/TRIM2 with 6 and the Limit of Detection for GSM

The binding capacity of MIP-GSMS/MAA/TRIM2 for the tagged analogue 6 with was measured and 6 was shown to be a moderately weaker binder as compared to GSM (FIG. 10b).

Typically, 1.37 mmol L⁻¹ of GSM or tag 6 solutions were prepared using acetonitrile as the solvent. The as-prepared solution (1 mL) was then added to 15 mg of MIP-GSMS/MAA/TRIM2 and mixed for 1 h. The mixtures were then centrifuged and the supernatants were analysed for GSM using GC-MS. The binding capacity, Q (μmol g⁻¹) of the MIPs and NIPs was calculated using Eq. (1) in Example 2.

For quantification by fluorescence spectroscopy, the mixture of MIP-GSMS/MAA/TRIM2 and tag 6 solution was centrifuged and the supernatant was extracted for quantification of the fluorescence intensity by a fluorescent spectrometer. The visual photo with fluorescence was observed using a UV lamp with an excitation wavelength of 350 nm.

In the initial studies, the limit of detection (LOD) for GSM, which provided information on the sensitivity of the assay, was determined to be 80 ppb (parts per billion). From repeated studies, the LOD was found to be 0.38 μM (69 μg L⁻¹) without pre-concentration. The LOD was calculated based on 3σ/s, where σ is the standard deviation of the blank measurements, and s is the slope of the calibration curve. The amount of fluorescent tag 6 as displaced in relation to the concentration of GSM in the water samples is as shown in FIG. 10c. In addition, there was an obvious, visible fluorescence difference between the blank and GSM samples, as shown in FIGS. 10d and e.

### Example 9. Detection of 2-MIB Using MIP-MIBS/MAA/EGDMA2 and a Fluorescent Tag 8

Synthesis of Cyclohexyl 2-(7-Amino-4-Methyl-2-Oxo-2H-Chromen-3-Yl)Acetate (8)

The fluorescent tag 8 for MIP-MIBS was synthesised by conjugating 7-amino-4-methyl-3-coumaric acid (5) with cyclohexanol (7), which is a partial structure of 2-MIB. The synthesis conditions were similar to that of 6 (see Example 8), except that cyclohexanol was used instead of cis-decahydro-1-naphthol (FIG. 11a). After working up the reaction, the crude residue was purified by flash chromatography (PE/EtOAc, 3:2 to 1:1) to give conjugate 8 (20.5 mg, 15%) as a white solid. ¹H NMR (400 MHz, DMSO-d₆) δ 7.47 (d, J=8.8 Hz, 1H), 6.58 (dd, J=8.8, 2.0 Hz, 1H), 6.41 (d, J=2.0 Hz, 1H), 6.07 (s, 2H), 4.65-4.69 (m, 1H), 3.26 (s, 2H), 2.27 (s, 3H), 1.73-1.76 9 m, 2H), 1.60-1.64 (m, 2H), 1.23-1.42 (m, 6H); ¹³C NMR (100 MHz, DMSO-d₆) δ 169.8, 161.5, 154.0, 152.5, 149.8, 126.4, 112.4, 111.4, 109.0, 98.4, 72.2, 32.7, 31.0, 24.8, 23.0, 14.8; ESI-MS: (m/z) 316.1 calcd for C₁₈H₂₁NO₄ [M+H]⁺, found 316.2.

Binding Capacity of 8 and the Limit of Detection for 2-MIB

The binding capacity of MIP-MIBS/MAA/EDGMA2 on tag 8 and 2-MIB in acetonitrile were determined by the method described in Example 8. The binding capacity of the polymer with regard to fluorescent tag 8 in 1 mL of acetonitrile was determined to be 9.2 μmol/g, whereas the binding capacity for 2-MIB in 1 mL acetonitrile was 21.4 μmol/g.

In the initial studies, the LOD for the detection for 2-MIB was found to be 60 ppb (parts per billion). With repeated studies and using a similar methodology as outlined in Example 8, the LOD for the detection of MIB was determined to be 0.29 μM (48 μg L⁻¹) without pre-concentration. The amount of fluorescent tag 8 as displaced in relation to the concentration of 2-MIB in the water samples is as shown in FIG. 11b.

### Example 10. Selectivity of MIP-GSMS/MAA/TRIM2 for GSM in the Presence of Amine Contaminants in Water

One of the concerns with the use of MAA as the monomer in the synthesis of MIP is the possibility of false positives from the interaction of amines that may be present in water samples. As such, competitive rebinding tests of the MIP with GSM and common amines in the river/reservoir water were conducted. 1-Naphthylamine was chosen as it was reported to be an important pollutant in the river water (M. Akyuz and S. Ata, J. Chromatogr. A., 2006, 1129, 88-94).

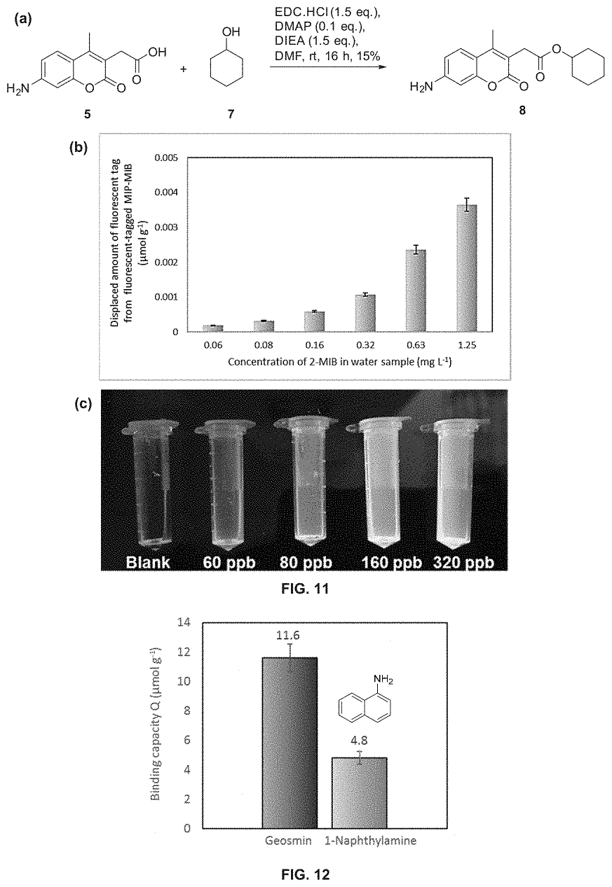

The binding capacity of MIP-GSMS/MAA/TRIM2 for GSM and 1-naphthylamine respectively, at a concentration of 1.37 mmol/L in water samples, was determined. As shown in FIG. 12, the binding capacity obtained for 1-naphthylamine was 4.8 μmol g⁻¹, which was much lower than that obtained for GSM.

In addition, the competitive rebinding capacity test of MIP-GSMS/MAA/TRIM2 towards GSM was also evaluated in the presence of 1-naphthylamine, with each at the same concentration of 1.37 mmol/L. It was observed that there was negligible variation (about 7%) in the observed binding capacity of MIP-GSMS/MAA/TRIM2 towards GSM in the presence of the amine. This demonstrated that MIP-GSMS/MAA/TRIM2 was highly selective towards GSM over the amine.

### Example 11. Detection of GSM in Field Samples from Water Reservoirs

Pre-Concentration of Water Samples Containing GSM by Solid Phase Extraction (SPE)

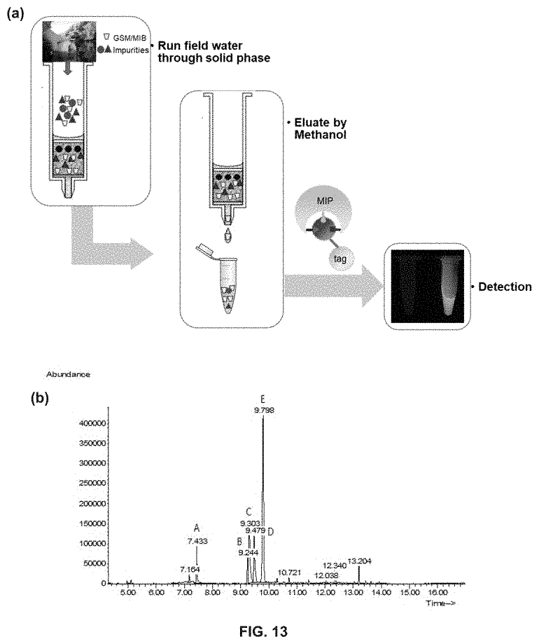

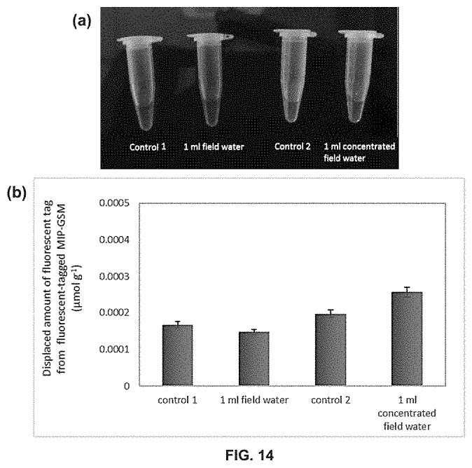

In order to detect GSM and MIB in field water samples, it is necessary to introduce a pre-concentration step which involves solid phase extraction (SPE) (FIG. 13a). Typically, the samples were first passed through a sorbent which captured the target analytes and a small amount of the other material(s) in the analyte sample. The sorbent was then eluted with a suitable media to extract the analytes from the sorbent and was finally obtained at a higher concentration, along with the small amount of the other material(s) that were also trapped. However, no interference from these other materials affected the detection of the target molecule, as shown in FIG. 14.

Specifically, 2 L of the field water solution with 10 ng L⁻¹ of GSM was subjected to pre-concentration on SPE column (12 mL, filled with 2 g of MIP-GSMS/MAA/TRIM2). The column was first pre-conditioned by passing through 12 mL of methanol followed by 12 mL of deionised water at a flow rate of one drop per second. After which, the sample solution was passed through the column at a rate of 4 mL/min and the column was dried by passing air through for 10 min. The analytes that were bound to the sorbent were then manually eluted using 12 mL of methanol, at a rate of 1 mL/min. The volume of the eluate was then reduced to 0.5 mL using a rotary evaporator. The concentration of GSM after pre-concentration was determined by GC-MS and the enrichment factor was calculated using the equation:

Enrichment factor=C_{final}/Cᵢₙᵢₜᵢₐₗ,

where Cᵢₙᵢₜᵢₐₗ was the concentration of GSM in the field sample before pre-concentration, and C_{final} was the concentration of GSM in the field sample after pre-concentration.

The GSM water samples (2 L each) concentrations were 25 ppt, 250 ppt, 2.5 ppb, 25 ppb and 50 ppb. These sample solutions were subjected to the SPE procedure on Strata C18-E SPE columns (12 mL, 2 g, Strata, Phenomenex, USA). The procedure was optimised for various analytical parameters (e.g. concentration of the water sample), elution conditions (e.g. volume of eluent, flow rate), and choice of sorbent and its adsorption capacity. Consequently, this gave an enrichment factor of 3230 and high recoveries of 85% with SPE followed by rotary evaporator. With this SPE, the LOD of GSM can be lowered down to 20 ppt. C18 silica (12 mL, 2 g, Strata, Phenomenex, USA) was chosen as the sorbent due to its commercial availability and ease of application. In addition, the C18 column gave high recovery, easy elution and adsorption capacity.

To improve the selectivity and adsorption of the sorbent towards GSM or 2-MIB, MIP-GSMS/MAA/TRIM2 or MIP-MIBS/MAA/EGDMA2 was used as the SPE sorbent instead. By following the same procedure as mentioned above, the binding efficiency (MIP/NIP) and binding selectivity for GSM/MIB improved to 2.6 and 3.2 respectively as compared to that of the C18 column. Using a MIP sorbent, the enrichment factor may be as high as 3490.

GSM Detection by Fluorescent-Tagged MIP-GSMS/MAA/TRIM2 Using Water Samples from Water Catchment Reservoirs

In order to verify that the pre-concentration step and the detection system can be carried out with water samples from reservoir, 1 L of field sample (reservoir water) was pre-concentrated using 2 g of MIP-GSMS/MAA/TRIM2 as sorbent and subsequently eluted with methanol to give a final volume of 1 mL. The composition of the concentrated sample was analysed using GC-MS and some major components in the water sample were identified as 2-(2-butoxyethoxy)ethan-1-ol and 2,4,7,9-tetramethyldec-5-yne-4,7-diol (FIG. 13b).

15 mg of MIP-GSMS/MAA/TRIM2 with bound fluorescent tag compound 6 was then incubated with 1 mL of untreated field water containing 10 ng L⁻¹ of GSM and 1 mL of concentrated field water, respectively. After incubation, the sample was filtered through a syringe filter of pore size 0.22 μm to remove the MIPs before detection. Alternatively, the sample can be separated by centrifugation before the supernatant was extracted for analysis. There was no visually observable difference in the intensity of the fluorescence of the two samples and this was further confirmed by fluorescent spectroscopy (FIGS. 14a and b). These results showed that the presence of water contaminants did not displace the fluorescent tag from the MIPs and therefore did not give false positive results. When the pre-concentrated water sample was spiked with 80 μg L⁻¹ GSM, fluorescence was observed and this was further confirmed by fluorescent spectroscopy. The amount of fluorescence obtained from the displaced fluorescent tagged MIP-GSM was determined to be 0.00034 μmol/g and this result was comparable with the detection result as shown in FIG. 10c. These results showed that GSM at 80 μg L⁻¹ can be detected in water samples and that the presence of water contaminants did not affect the outcome.

1. A molecularly imprinted polymer suitable for the detection of a target molecule, the polymer comprising a crosslinked polymer with a plurality of cavities, where:
the polymer is formed from a functional monomer selected from one or more of the group consisting of methacrylic acid, methyacrylamide, and methyl methacrylate and a crosslinking agent selected ethylene glycol dimethacrylate and/or trimethylolpropane trimethacrylate;
the cavities have a first affinity for a surrogate molecule and a second affinity for the target molecule, where the first affinity is greater than or equal to the second affinity, wherein the molecularly imprinted polymer has:
a binding capacity for the target molecule that is at least 60% of the binding capacity obtained from a molecularly imprinted polymer produced using the target molecule itself; and
a binding capacity for the target molecule that is from 10 to 30 μmol/g.

2. The polymer according to claim 1, wherein:
(a) the ratio of functional monomer to crosslinking agent is from 1:1 to 1:2.5; and/or
(b) the polymer has a binding efficiency for the target molecule that is greater than or equal to 2.

3. The polymer according to claim 2, wherein the polymer further comprises a fluorescently-labelled surrogate of the target molecule where the surrogate is a weaker binder than the target molecule, such that it is displaced from the polymer upon exposure of the polymer to the target molecule.

4. The polymer according to claim 1, wherein the target molecule is geosmin.

5. The polymer according to claim 4, wherein one or more of the following apply:
(a) the polymer has a binding capacity of from 10 to 15 μmol/g, such as 11.6 μmol/g for geosmin;
(b) the functional monomer is methacrylic acid, the crosslinking agent is trimethylolpropane trimethacrylate and the ratio of functional monomer:crosslinking agent is 1:1; and
(c) the polymer further comprises a fluorescently-labelled surrogate of geosmin where the surrogate is a weaker binder than geosmin, such that it is displaced from the polymer upon exposure of the polymer to geosmin.

6. The polymer according to claim 4, wherein the fluorescently-labelled surrogate of geosmin is [(4aS,8aS)-decalin-1-yl]-2-(7-amino-4-methyl-2-oxo-chromen-3-yl)acetate).

7. The polymer according claim 3, wherein the target molecule is 2-methylisoborneol.

8. The polymer according to claim 7, wherein one or more of the following apply:
(a) the polymer has a binding capacity of from 15 to 20 μmol/g, such as 18.9 μmol/g for 2-methylisoborneol;
(b) the functional monomer is methacrylic acid, the crosslinking agent is ethylene glycol dimethacrylate and the ratio of functional monomer:crosslinking agent is 1:2.5;
(c) the polymer further comprises a fluorescently-labelled surrogate of 2-methylisoborneol where the surrogate is a weaker binder than 2-methylisoborneol, such that it is displaced from the polymer upon exposure of the polymer to 2-methylisoborneol.

9. The polymer according to claim 7, wherein the fluorescently-labelled surrogate of 2-methylisoborneol is cyclohexyl-2-(7-amino-4-methyl-2-oxo-chromen-3-yl)acetate.

10. A method of detecting the concentration of a target molecule in a sample with a molecularly imprinted polymer, wherein the method comprises the steps of:
providing a molecularly imprinted polymer comprising a crosslinked polymer with a plurality of cavities, where;
the polymer is formed from a functional monomer selected from one or more of the group consisting of methacrylic acid, methyacrylamide, and methyl methacrylate and a crosslinking agent selected ethylene glycol dimethacrylate and/or trimethylolpropane trimethacrylate;
the cavities have a first affinity for a surrogate molecule and a second affinity for the target molecule, where the first affinity is greater than or equal to the second affinity, wherein the molecularly imprinted polymer has:
a binding capacity for the target molecule that is at least 60% of the binding capacity obtained from a molecularly imprinted polymer produced using the target molecule itself; and
a binding capacity for the target molecule that is from 10 to 30 μmol/g; and
wherein the polymer further comprises a fluorescently-labelled surrogate of the target molecule where the surrogate is a weaker binder than the target molecule, such that it is displaced from the polymer upon exposure of the polymer to the target molecule; and
providing a sample for analysis;
(b) contacting the molecularly imprinted polymer with the sample for a period of time to form a sample-polymer mixture;
(c) separating the sample-polymer mixture to provide a contacted sample; and
(d) qualitatively detecting the presence of the target molecule in the contacted sample by observing the presence of fluorescence in the contacted sample or quantitatively determining the concentration of the target molecule in the contacted sample by measuring the fluorescence in the contacted sample using a fluorescence spectrometer.

11. The method according to claim 10, wherein before step (b), the sample is subjected to a preconcentration process that comprises the steps of:
(i) contacting the sample with a preconcentration material to capture at least the target molecule;
(ii) subsequently releasing the target molecule from the preconcentration material to provide a preconcentrated sample that is then used in steps (b) to (d) claim 10.

12. A device to detect a target molecule qualitatively and/or quantitatively in a sample for analysis, where the device comprises:
a preconcentration section to receive a sample and capture at least the target molecule on a preconcentration material;
a preconcentration sample section to receive a preconcentrated sample from the preconcentration section; and
a detection section that receives the preconcentrated sample and qualtatively and/or quantitatively detects the target molecule, wherein:
the detection section comprises a molecularly imprinted polymer as described in claim 3.

13. A method for providing a molecularly imprinted polymer using a surrogate molecule in place of a target molecule, the process comprising the steps of:
(i) selecting a target molecule and then selecting a surrogate molecule having a shape similarity score of at least 0.80; and
(ii) using the surrogate molecule to form a library molecularly imprinted polymers by reaction of a functional monomer and a crosslinking agent in the presence of the surrogate molecule, where the ratio of surrogate molecule to functional monomer is from 1:2 to 1:6 and the ratio of functional monomer to crosslinking agent in each library member is from 1:1 to 1:2.5 and establishing the binding capacity (Q_{MIP}) for each library member to the target molecule and/or the surrogate molecule;
(iii) forming a corresponding library of non-molecularly imprinted polymers by reaction of a functional monomer and a crosslinking agent in the absence of the surrogate molecule, where the ratio of functional monomer:crosslinking agent in each library member is from 1:1 to 1:2.5 and establishing the binding capacity (Q_{NIP}) for each library member to the target molecule and/or the surrogate molecule;
(iv) selecting a molecularly imprinted polymer for use in detection of the target molecule where the binding efficiency of the molecularly imprinted polymer (Q_{MIP} divided by the corresponding Q_{NIP}) is greater than or equal to 2 for the target molecule and/or or greater than or equal to 2.5 for the surrogate molecule.

14. The method according to claim 13, wherein:
(a) the functional monomer is selected from one or more of the group consisting methacrylic acid, methyacrylamide, and methyl methacrylate; and/or
(b) the crosslinking agent is selected from one or more of the group consisting of ethylene glycol dimethacrylate and trimethylolpropane trimethacrylate.

15. The method according to claim 13, wherein the target molecule is a metabolite of a microorganism.

16. The method according to claim 15, wherein the metabolite is geosmin or 2-methylisoborneol.

17. The method according to claim 13, wherein the ratio where the ratio of surrogate molecule to functional monomer is from 1:2 to 1:4 and the ratio of functional monomer to crosslinking agent is from 1:1 to 1:2.5.

18. The method according to claim 13, wherein the reaction of a functional monomer and a crosslinking agent in the presence of the surrogate molecule is a self-assembly reaction.

19. The method according to claim 13, wherein the molecularly imprinted polymer selected in step (iv) of claim 1 is the polymer with the greatest binding efficiency.

20. The method according to claim 13, wherein the method further comprises a step of forming a detection device comprising the selected molecularly imprinted polymer.
